(19) United States
(12) Patent Application Publication
(10) Pub. No.: US 2021/0061555 A1
(43) Pub. Date: Mar. 4, 2021

(54) GARBAGE BIN WITH FILTER CASE

(71) Applicant: Michael SHEK, San Mateo, CA (US)

(72) Inventor: Michael SHEK, San Mateo, CA (US)

(21) Appl. No.: 16/550,850

(22) Filed: Aug. 26, 2019

(51) Int. Cl. B65F 1/16; B65F 7/00; B01D 46/00; B01D 46/12

(52) U.S. Cl. CPC B65F 1/163; B65F 7/00; B01D 46/0036; B65F 2210/129; B01D 46/12; B65F 2210/1026; B01D 46/0038

(57) ABSTRACT

A garbage bin with filter case includes a barrel, a lid, and a filter case assembly. The barrel has a receiving space and an opening at the top. The lid is pivotally disposed on the top of the barrel to selectively close the opening. The lid has a bottom face facing the receiving space. The filter case assembly includes a case and a connecting mount. The case is fixed to the lid via the connecting mount so that the case is separated from the bottom face of the lid to form a gap between the case and the lid. The case encloses a filter room therein for receiving a filter and has plural through holes formed on at least a face opposite to the bottom face of the lid and a face facing the bottom face of the lid. The through holes communicate the filter room.

### BACKGROUND OF THE INVENTION

### Field of the Invention

The present invention relates to a garbage bin with filter case.

### Description of the Prior Art

Generally, filter is used to absorb the smelly air in the garbage bin. The filter is usually adhered onto the lid of the garbage bin. However, only the face of the filter facing the garbage bin is exposed in the air so that the efficiency of filtration is not good enough.

U.S. Pat. No. 8,418,869 shows a solution to the problem mentioned above. The lid has some air channels and a cavity communicating the air channels. The cavity communicates to the face of the filter opposite to the garbage bin, so the air in the garbage bin can reach the face of the filter opposite to the garbage bin via the air channels and the cavity to improve the efficiency of filtration. However, the structure of the lid is extremely complicated and difficult to manufacture. In addition, the efficiency that the air flows to the cavity is quite bad. Furthermore, the structure is impossible to be applied in a conventional garbage bin.

### SUMMARY OF THE INVENTION

The main object of the present invention is to provide a garbage bin having a filter case which is able to improve the performance of the filter.

To achieve the above and other objects, the garbage bin with filter case of the present invention includes a barrel, a lid, and at least one filter case assembly.

The barrel has a receiving space and an opening at a top thereof. The lid is pivotally disposed on the top of the barrel to selectively close the opening. The lid has a bottom face facing the receiving space when the lid closes the opening of the barrel. The at least one filter case assembly includes a case and a connecting mount. The case is fixed to the lid via the connecting mount so that the case is separated from the bottom face of the lid to form a gap between the case and the lid. The case encloses a filter room therein for receiving a filter and has a plurality of through holes formed on at least a face opposite to the bottom face of the lid and a face facing the bottom face of the lid. The through holes communicate the filter room.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIG. 2 is a breakdown drawing of the present invention;

FIG. 3 is a breakdown drawing showing a filter case assembly of the present invention;

FIG. 4 is a profile of the present invention;

FIG. 5 is an illustration showing a second embodiment of the present invention.

### DETAILED DESCRIPTION OF THE PREFERRED EMBODIMENTS

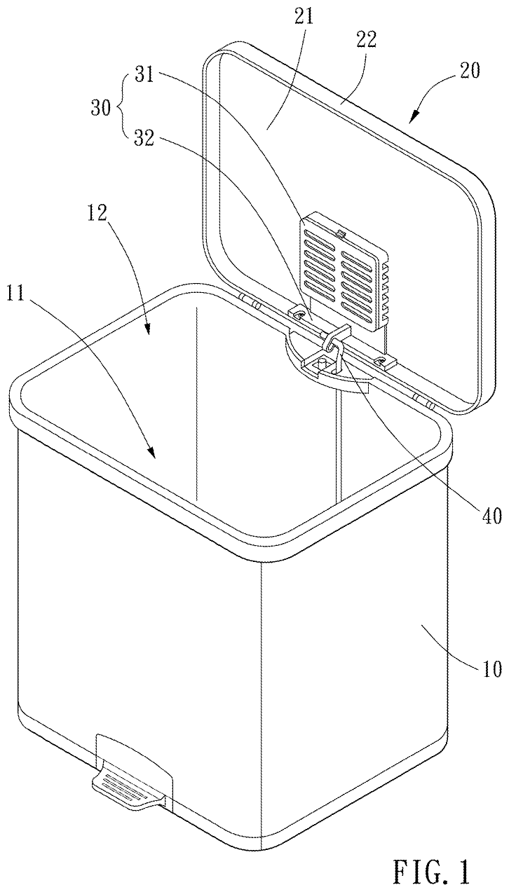

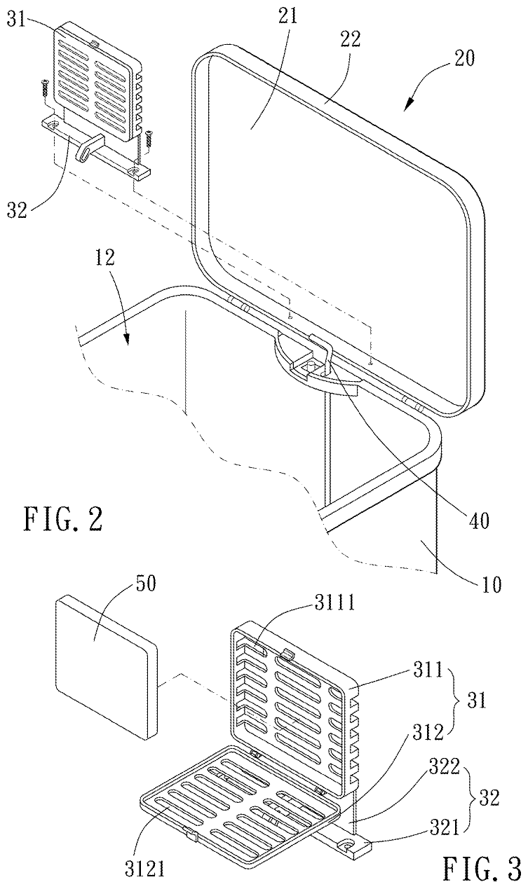

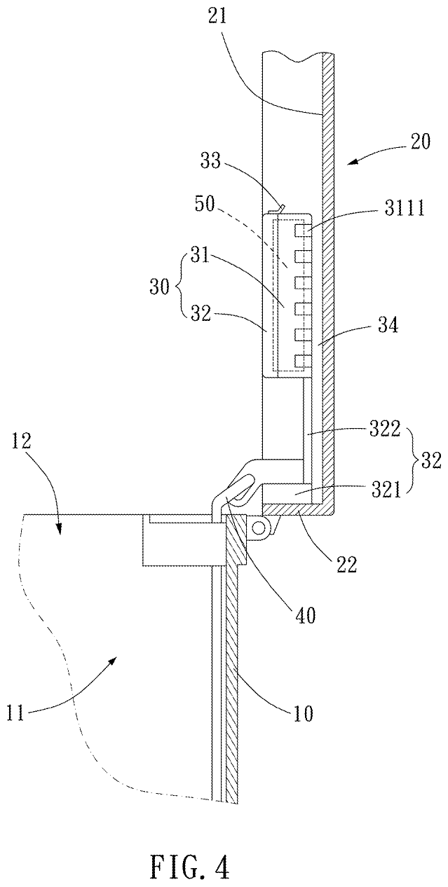

Please refer to FIG. 1 to FIG. 4, the garbage bin with filter case of the present invention includes a barrel 10, a lid 20, and at least one filter case assembly 30.

The barrel 10 has a receiving space 11 and an opening 12 at a top thereof The lid 20 is pivotally disposed on the top of the barrel 10 to selectively close the opening 12. The lid 20 has a bottom face 21 facing the receiving space 11 when the lid 20 closes the opening 12 of the barrel 10. The at least one filter case assembly 30 includes a case 31 and a connecting mount 32. The case 31 is fixed to the lid 20 via the connecting mount 32 so that the case 31 is separated from the bottom face 21 of the lid 20 to form a gap 34 between the case 31 and the lid 20. The case 31 encloses a filter room therein for receiving a filter 50 and has a plurality of through holes 3111,3121 formed on at least a face opposite to the bottom face 21 of the lid 20 and a face facing the bottom face 21 of the lid 20. The through holes 3111, 3121 communicate the filter room. Preferably, the case has a plurality of said through holes also formed on the lateral sides thereof to make the case have at least four sides for communicating the receiving space so as to increase the surface area of filtration.

In the present embodiment, the lid 20 has a flange 22 surrounding the bottom face 21 of the lid 20 and extending toward the barrel 10, and the connecting mount 32 is disposed on an inner face of the flange 22. However, in other possible embodiments, the connecting mount can be disposed on the bottom face of the lid directly. Besides, the case 31 includes a case body 311 and a case cover 312. The case body 311 is disposed on the connecting mount 32. The case cover 312 is pivotally disposed on the case body 311 to selectively cover a face of the case body 311 away from the bottom face 21 of the lid 20 so that the case cover 312 can be pivoted away from the case body 311 for exchanging the filter. The filter room is defined between the case body 311 and the case cover 312. Each of the case body 311 and the case cover 312 is formed with at least one said through hole 3111,3121. Preferably, the case 30 further includes a buckle structure 33. The buckle structure 33 is arranged between the case body 311 and the case cover 312 so that the case cover 312 is detachably buckled to the case body 311 to close the case body 311. In addition, the connecting mount 32 includes a seat 321 and a connecting plate 322. The seat 321 is disposed on the lid 20. The connecting plate 322 connects the seat 321 and the case 31 therebetween. The connecting plate 322 is separated from the bottom face 21 of the lid 20.

Furthermore, the garbage bin having filter case of the present invention further including a lifting structure 40 arranged between the lid 20 and the barrel 10 at a pivot portion thereof for opening the lid 20. The connecting mount 32 is disposed on the inner face of the flange 22 near the pivoting portion, and an end of the lifting structure 40 is connected to the connecting mount 32.

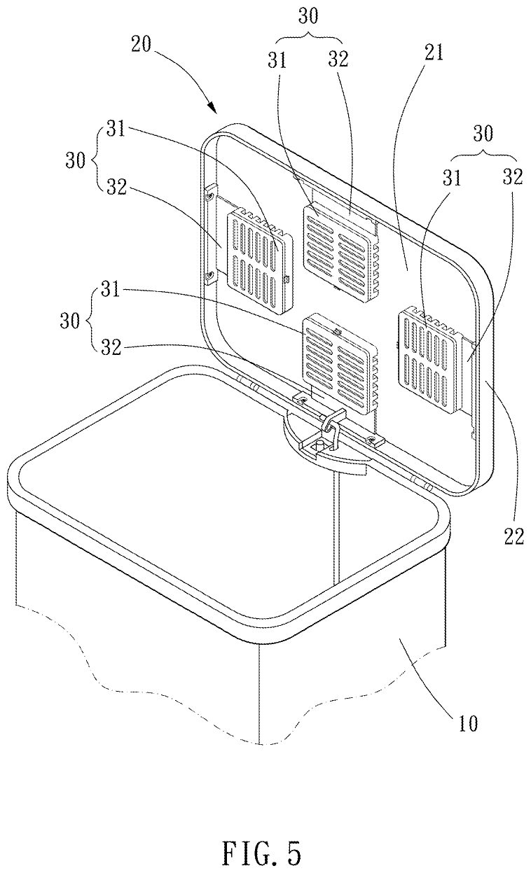

In other possible embodiments, a plurality of said filter case assemblies 30 can be included. The filter case assemblies 30 are spacedly arranged along the flange 22 of the lid 20, as shown in FIG. 5.

In view of the through holes, each of the through holes 3111, 3121 is an elongated hole in the present embodiment. At least one of the through holes 3111 on the case body 311 extends to penetrate a lateral face of the case body 311. In other possible embodiments, the lateral faces of the case 31 can be formed with said through holes too.

Because the case is separated from the lid to form a gap therebetween, the face of the case facing the lid can be formed with through holes to improve the efficiency of air-filtering. In addition, the filter case assembly can be installed on the lid of any conventional garbage bin to simplify the process of manufacturing. More filter case assemblies can be installed onto the lid if needed.

What is claimed is:

1. A garbage bin with filter case, including:
a barrel, having a receiving space and an opening at a top thereof;
a lid, pivotally disposed on the top of the barrel to selectively close the opening, the lid having a bottom face facing the receiving space when the lid closes the opening of the barrel;
at least one filter case assembly, including a case and a connecting mount, the case being fixed to the lid via the connecting mount so that the case is separated from the bottom face of the lid to form a gap between the case and the lid, the case enclosing a filter room therein for receiving a filter and having a plurality of through holes formed on at least a face opposite to the bottom face of the lid and a face facing the bottom face of the lid, the through holes communicating the filter room.

2. The garbage bin with filter case of claim 1, wherein the lid has a flange surrounding the bottom face of the lid and extending toward the barrel, the connecting mount is disposed on an inner face of the flange.

3. The garbage bin with filter case of claim 1, wherein the case includes a case body and a case cover, the case body is disposed on the connecting mount, the case cover is pivotally disposed on the case body to selectively cover a face of the case body away from the bottom face of the lid, the filter room is defined between the case body and the case cover, each of the case body and the case cover is formed with at least one said through hole.

4. The garbage bin with filter case of claim 3, further including a lifting structure arranged between the lid and the barrel at a pivot portion thereof for opening the lid, the connecting mount is disposed on the inner face of the flange near the pivoting portion, an end of the lifting structure is connected to the connecting mount.

5. The garbage bin with filter case of claim 3, wherein the case further includes a buckle structure, the buckle structure is arranged between the case body and the case cover so that the case cover is detachably buckled to the case body to close the case body.

6. The garbage bin with filter case of claim 1, wherein the connecting mount includes a seat and a connecting plate, the seat is disposed on the lid, the connecting plate connects the seat and the case therebetween, the connecting plate is separated from the bottom face of the lid.

7. The garbage bin with filter case of claim 2, including a plurality of said filter case assemblies, the filter case assemblies being spacedly arranged along the flange of the lid.

8. The garbage bin with filter case of claim 1, wherein each of the through holes is an elongated hole.

9. The garbage bin with filter case of claim 4, wherein each of the through holes is an elongated hole, at least one of the through holes on the case body extends to penetrate a lateral face of the case body.
